(19) United States
(12) Patent Application Publication
(10) Pub. No.: US 2014/0248516 A1
(43) Pub. Date: Sep. 4, 2014

(54) POWER SUPPLY DEVICE

(71) Applicant: YAZAKI CORPORATION, Tokyo (JP)

(72) Inventor: Nobuaki YOSHIOKA, Kakegawa-shi (JP)

(73) Assignee: YAZAKI CORPORATION, Tokyo (JP)

(21) Appl. No.: 14/278,104

(22) Filed: May 15, 2014

Related U.S. Application Data
(63) Continuation of application No. PCT/JP2012/007294, filed on Nov. 14, 2012.

(30) Foreign Application Priority Data
Nov. 16, 2011 (JP) 2011-250500

(51) Int. Cl. H01M 10/48

(52) U.S. Cl. CPC H01M 10/482
USPC 429/90

(57) ABSTRACT

A power supply device comprises: a battery assembly including stacked battery cells, the battery cells having electrodes, the electrodes of the adjacent battery cells being placed opposite to one another; and a battery linking body disposed on a side at which the electrodes of the battery assembly protrude, the battery linking body being configured to cover the protruding electrodes, the battery linking body including: a terminal connected to the electrodes placed opposite to one another, and a circuit pattern for voltage detection, the circuit pattern being connected to the terminal by a electrically conductive portion.

### CROSS REFERENCE TO RELATED APPLICATIONS

This application is a continuation application of International Application No. PCT/JP2012/007294, filed on Nov. 14, 2012, which claims priority to Japanese Patent Application No. 2011-250500, filed on Nov. 16, 2011, the entire contents of which are incorporated by references herein.

### BACKGROUND OF THE INVENTION

1. Field of the Invention

The present invention relates to a power supply device having stacked battery cells.

2. Description of the Related Art

Hybrid vehicles, electric vehicles and the like have a power supply device as a power source for driving an electric motor. Patent Application JP 2010-55885 A discloses such a power supply device as a conventional one. As shown in FIGS. 9 and 10, this power supply device 50 includes a battery assembly 51. The battery assembly 51 has stacked battery cells 52 that are arranged in two rows. Each battery cell 52 has a pair of electrodes (i.e. positive and negative electrodes) 52a and 52b provided on an upper surface thereof in protruding manner. Each pair of electrodes 52a and 52b of the adjacent battery cells 52 and 52 are electrically connected by a link terminal 53 and two clamp terminals 54 and 55. The link terminal 53 is formed as a part of a bus bar, and has a pair of linking contacts 53a and 53b. The linking contacts 53a and 53b are oriented corresponding to orientations of the electrodes 52a and 52b to be linked thereto. The clamp terminals 54 and 55 are formed as parts of a bus bar. The clamp terminal 54 clamps the electrode 52a of the batter cell 52 and the electrode 53a of the link terminal 53. The clamp terminal 55 clamps the electrode 52b of the batter cell 52 and the electrode 53b of the link terminal 53. A fork-shaped terminal 54A is integrally provided with the clamp terminal 54. A voltage checking wire W is pressed into the fork-shaped terminal 54A to electrically connect thereto. The link terminal 53 and the clamp terminals 54 and 55 are integrally fixed by a mounting member 56 which is made of synthetic resin.

In the conventional technique as described above, the battery cells 52 of the battery assembly 51 are connected in a series by the link terminal 53 and clamp terminal 54 and 55. Information on a voltage on the electrode of each battery cell 52 is output through the voltage checking wire W connected to the fork-shaped terminal 54a. Accordingly, an output status of each battery cells 52 can be detected.

### SUMMARY OF THE INVENTION

In the above conventional technique, the voltage checking wire W, the link terminal 53, the clamp terminals 54 and 55, and the mounting member 56 are used both to connect electrodes of adjacent battery cells 52 and 52 and to acquire the information on the voltages thereon. The voltage checking wire W, the link terminal 53, the clamp terminals 54 and 55, and the mounting member 56 are needed for every connection point of the adjacent electrodes. Therefore, the numbers of components, the assembling operations thereof and the like increase with increasing the number of battery cells 52 to be used. In addition, a space for setting the link terminal 53 and the clamp terminals 54 and 55 is needed for the every connection point. This unnecessarily causes the power supply device 50 to be larger and heavier.

The present invention has been made in order to solve the above problems, and the object thereof is to provide a power supply device which is capable of suppressing increase of the numbers of components and assembling operations thereof, and also which is capable of being miniaturized and being reduced in its weight.

An aspect of the present invention is a power supply device comprising: a battery assembly including stacked battery cells, the battery cells having electrodes, the electrodes of the adjacent battery cells being placed opposite to one another; and a battery linking body disposed on a side at which the electrodes of the battery assembly protrude, the battery linking body being configured to cover the protruding electrodes, the battery linking body including: an electrode connecting portion connected to the electrodes placed opposite to one another, and a substrate with a circuit pattern for voltage detection, the circuit pattern being connected to the electrode connecting portion thorough an electrically conductive portion.

The circuit pattern may include a land for electrode in the vicinity of the electrode connecting portion. The electrode connecting portion may be a terminal formed as a part of a bus bar, and the electrically conductive member may be a wire.

The electrode connecting portion may be a terminal formed as a part of a bus bar, and the electrically conductive member may be a tab integrally formed with the bus bar as a part thereof.

According to the present invention, the connections between the electrodes in respective pairs and the acquisition of the information on the voltages thereon can be achieved by the substrate, the electrode connecting portion and the electrically conductive portion. That is, the number of the components can be reduced compared with the conventional technique. Components required for every connection point of the paired electrodes are the electrode connecting portion and electrically conductive portion. These components can be set in a small space. Therefore, even if the number of the battery cells increase, it is possible to suppress increase of the numbers of the components and assembling operations thereof, as lower as possible. Thus, it is possible to miniaturize the device and reduce its weight.

### BRIEF DESCRIPTION OF THE DRAWINGS

FIG. 1 is a perspective view illustrating a power supply device according to a first embodiment of the present invention.

FIGS. 2A and 2B illustrate the first embodiment of the present invention. FIG. 2A is a perspective view illustrating a main part of the power supply device in which some insulating covers are dismounted, and FIG. 2B is a sectional view illustrating a connection state of paired electrodes and a terminal for electrode.

FIG. 3 is a perspective view illustrating a battery assembly according to the first embodiment of the present invention.

FIGS. 4A and 4B illustrate the first embodiment of the present invention. FIG. 4A is a perspective view illustrating a first battery cell, and FIG. 4B is a perspective view illustrating a second battery cell.

FIG. 5 is a perspective view illustrating a battery cell linking body according to the first embodiment of the present invention, in which some insulating covers are dismounted.

FIG. 6 is a perspective view illustrating a battery cell linking body according to the first embodiment of the present invention, in which all insulating covers are dismounted.

FIG. 7 is a perspective view illustrating a battery cell linking body according to a second embodiment of the present invention, in which some insulating covers are dismounted.

FIG. 8 is a close view illustrating a part indicated by “C” in FIG. 7.

FIG. 9 is an exploded perspective view of a conventional power supply device.

FIG. 10 is an expanded perspective view illustrating a main part of the conventional power supply device.

### DESCRIPTION OF THE PREFERRED EMBODIMENTS

Hereinafter, embodiments of the present invention are described with reference to the drawings.

### First Embodiment

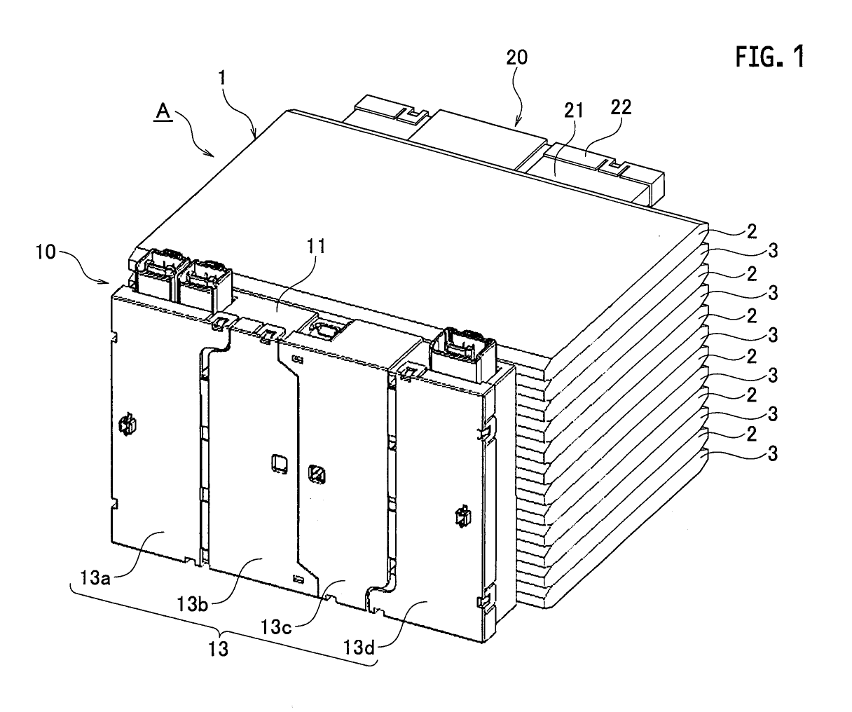

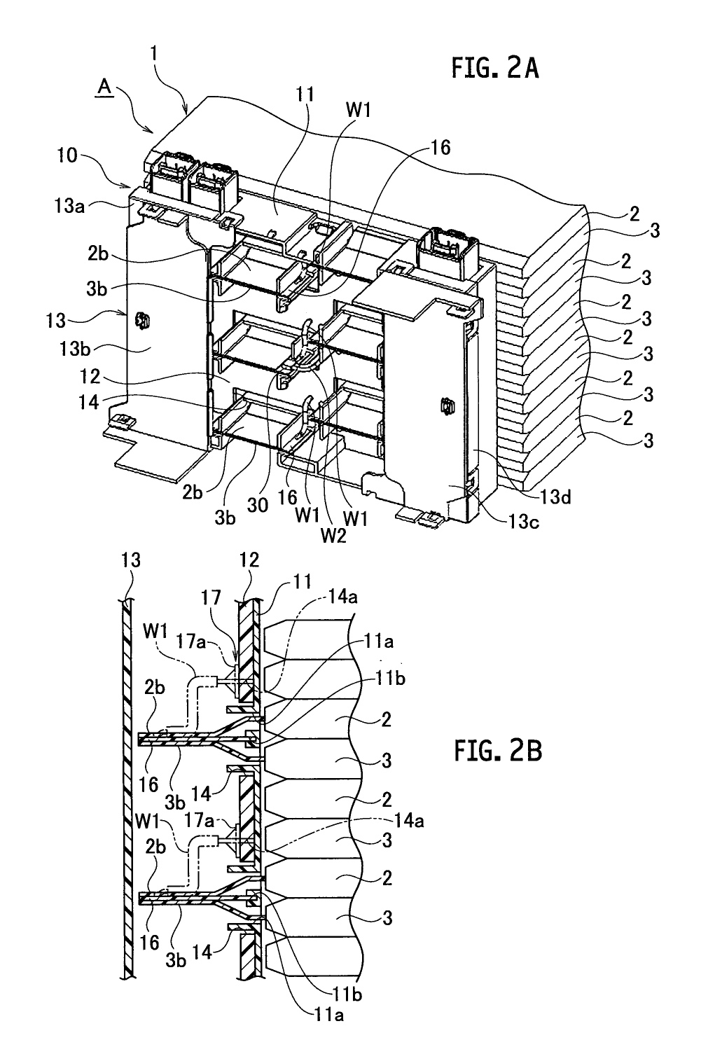

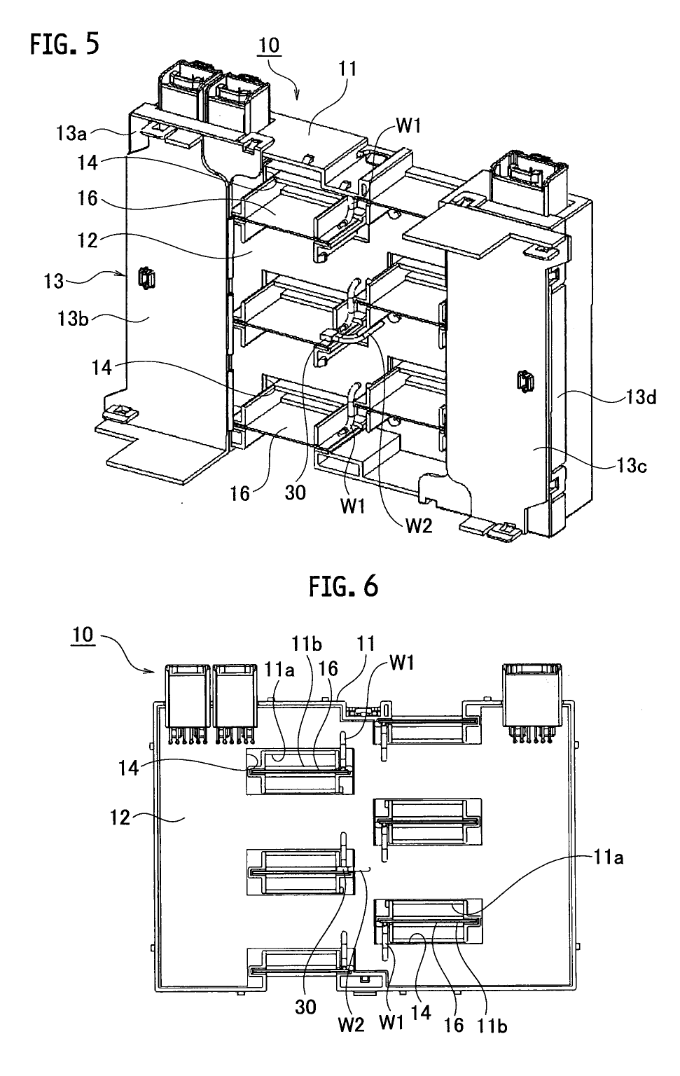

FIGS. 1 to 6 illustrate a first embodiment of the present invention. As illustrated in FIGS. 1 and 2A, a power supply device A comprises: a battery assembly 1 including stacked battery cells 2 and 3 (total twelve cells in this embodiment, for example); and a pair of battery linking bodies 10 and 20 disposed on both sides of the battery assembly 1.

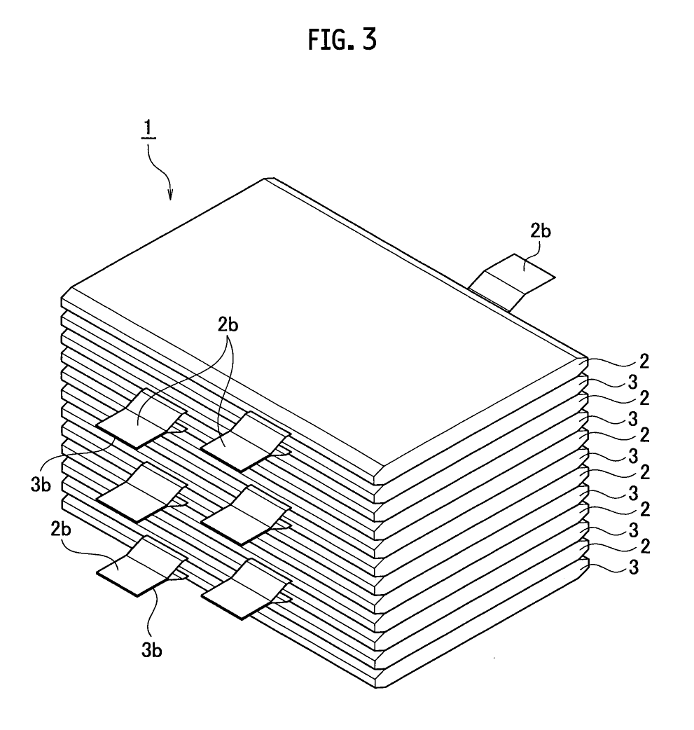

As illustrated in FIG. 3 in detail, the battery assembly 1 comprises twelve battery cells 2 and 3. Hereinafter, the battery cell 2 is referred to a first battery cell 2, and the battery cell 3 is referred to a second battery cell 3. The first battery cell has electrodes 2b, and the second battery cell has electrodes 3b. The positions of the electrodes 2b and 3b are different to each other.

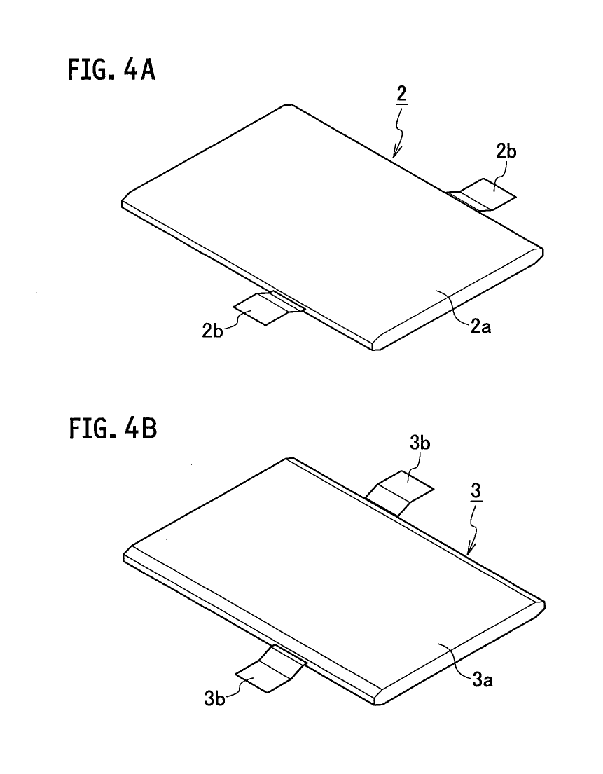

As illustrated in FIG. 4A, the first battery cell 2 includes a battery cell main body 2a formed into a rectangular and flat shape, a pair of electrodes (i.e. positive and negative electrodes) 2b and 2b respectively protruding from left and right side surfaces of the battery cell main body 2a. One of the paired electrodes 2b and 2b protrudes at the front side of the battery cell main body 2a, and the other one protrudes at the back side thereof. Both electrodes 2b and 2b are arranged at the same side of the battery cell main body 2a with reference to a center line of the battery cell main body 2a. That is, even when the battery cell main body 2a is flipped so that its front side is arranged to the backside or vice versa, the paired electrodes 2b and 2b are located at the same positions in a plan view except that their original left and right positions are reversed. Each electrode 2b is formed into a thin film, thin plate or the like.

As illustrated in FIG. 4B, the second battery cell 3 includes a battery cell main body 3a formed into a rectangular and flat shape, a pair of electrodes (i.e. positive and negative electrodes) 3b and 3b respectively protruding from left and right side surfaces of the battery cell main body 3a. One of the paired electrodes 3b and 3b protrudes at the front side of the battery cell main body 3a, and the other one protrudes at the back side thereof. Both electrodes 3b and 3b are arranged at the same side of the battery cell main body 3a with reference to a center line of the battery cell main body 3a. That is, even when the battery cell main body 3a is flipped so that its front side is arranged to the backside or vice versa, the paired electrodes 3b and 3b are located at the same positions in a plan view except that their original left and right positions are reversed. Each electrode 3b is formed into a thin film, thin plate or the like.

As illustrated in FIG. 3, the first and second battery cells 2 and 3 having the above configurations are alternately stacked. In this case, the electrodes 2b and 3b of the adjacent first and second battery cells 2 and 3, which have opposite polarities, are placed opposite to each other in contact with one another.

Accordingly, in the battery assembly 1, the twelve battery cells 2 and 3 are connected in series.

As illustrated in FIGS. 2A, 5 and 6 in detail, the battery linking body 10 comprises: an insulating case main body 11; a substrate 12 disposed in a frame of the insulating case main body 11; an insulating cover 13 covering a space in the frame of the insulating case main body 11 from the outside.

The insulating case main body 11 is provided with electrode insertion holes 11a. The electrode insertion holes 11a are provided at six positions corresponding to the electrodes 2b and 3b protruding from one side of the battery assembly 1. Each electrode insertion hole 11a is divided into upper and lower portions (holes) by an electrode securing wall 11b provided in the middle of the electrode insertion hole 11a. A terminal 16 for electrode is fixed at each position of the electrode securing walls 11b. The terminal 16 serves as an electrode connecting portion. Each terminal 16 is formed as a part of a bus bar.

The substrate 12 is provided with electrode insertion holes 14. The electrode insertion holes 14 are located at positions corresponding to the electrodes 2b and 3b protruding from the one side of the battery assembly 1. That is, the electrode insertion holes 14 are located at the same positions of the electrode insertion holes 11a of the insulating case main body 11. As illustrated in FIGS. 2A and 2B, the electrodes 2b and 3b protruding from the one side of the battery assembly 1 are inserted through the corresponding electrode insertion holes 11a and 14 of the insulating case main body 11 and substrate 12. The inserted paired electrodes 2b and 3b are respectively arranged on upper and lower surfaces of the terminal 16 in contact with the terminal 16. The electrodes 2b and 3b are contacted to the terminal 16 by a connection method using ultrasonic waves, lasers or the like. As described above, the substrate 12 is mounted in a residual space in the insulating case main body 11, which is not occupied by the electrodes 2b and 3b and terminals 16. Accordingly the battery linking body 10 can be miniaturized.

A circuit pattern 17 for voltage detection (see FIG. 2B) is formed on the substrate 12. The circuit pattern 17 includes lands 17a for electrode in the vicinity of respective terminals 16 for electrode. A through hole 14a is formed in each land 17a of the substrate 12. Each land 17a is connected to the corresponding terminal 16 through a wire (electric wire) W1 which is electrically conductive member. The wire W1 is connected to the terminal 16 by soldering or the like. The wire W1 is connected to the land 17a by soldering or the like. In this connection, the wire W1 may be inserted into the through hole 14a to secure its position.

A thermistor 30 is fixed to one of the terminals 16 in the battery linking body 10. The thermistor 30 is connected to a circuit pattern for detecting heat generations (not shown) of the substrate 12 through a wire (electric wire) W2.

As described below, the information on voltages and heat generations on the electrodes 2b and 3b at both sides of the battery linking bodies 10 and 20 is sent to the substrate 12 via the wires W1 and W2. The substrate 12 has a circuit for detecting abnormal voltages of the battery cells 2 and 3, and the like. This circuit determines whether or not the output voltages of the battery cells 2 and 3 are abnormal.

The insulating cover 13 is composed of four divided covers 13a to 13d. The divided covers 13a and 13d constitute side parts of the insulating cover 13, and are attached to the insulating case main body 11. The divided covers 13b and 13c constitute middle parts of the insulating cover 13, and pivotally supported to the divided covers 13a and 13d, respectively. As illustrated in FIGS. 2A and 6, when the divided covers 13b and 13c are positioned at the open position, the six terminals 16 come to be exposed. When the divided covers 13b and 13c are positioned at the close position, an accommodation space for the substrate 12 and terminals 16 is covered (closed). When the divided covers 13b and 13c are at the close position, they are attached to the insulating case main body 11. Accordingly, the battery linking body 10 electrically insulates the electrode 2b and 3b that protrude from the one side of the battery assembly 1.

The battery linking body 20 has a similar configuration of the battery linking body 10. The battery linking body 20 includes an insulating case main body 21 (see FIG. 1) and an insulating cover 22 (also see FIG. 1). The battery linking body 20 electrically insulates the electrodes 2b and 3b that protrude from the other side of the battery assembly 1. The voltage information at the electrodes 2b and 3b disposed at the battery linking body 20 side are sent to the substrate 12 in the battery linking body 10 via a wire for voltage detection (not shown).

In the insulating case main body 21, a pair of output terminals (now shown) is provided. An output of the power supply device A is obtained from the pair of the output terminals.

Next, an outline of the assembling operations of the power supply device A will be described. The battery linking body 10 is approached to the battery assembly 1 along a direction in which the battery linking body 10 faces the one side of the battery assembly 1, and each pair of the electrodes 2b and 3b is inserted into the corresponding electrode insertion holes 11a and 14 of the insulating case main body 11 and substrate 12. With this insertion, the electrodes 2b and 3b in each pair are arranged on the upper and lower surfaces of the corresponding terminal 16, respectively. Next, the paired electrodes 2b and 3b are connected to the terminal 16 by the connection method using ultrasonic waves, lasers or the like. Thereafter, the divided covers 13b and 13c are set at the close position, and attached to the insulating case main body 11.

The battery linking body 20 is assembled in a similar way to the assembling operation of the battery linking body 10 as described above.

As described above, the power supply device A according to the present embodiment comprises: the battery assembly 1, and the battery linking bodies 10 and 20. The battery linking body 10 includes: at least one terminal 16 for electrode, the terminal 16 connecting to the pair of the electrodes 2b and 3b opposed to each other; and the substrate 12 including the circuit pattern 17 for voltage detection. The terminal 16 is connected to the circuit pattern 17 through the wire W1. Therefore, the connections between the electrodes 2b and 3b in respective pairs and the acquisition of the information on the voltages thereon can be achieved by the substrate 12, the terminal 16 and the wire W1. Specifically, the connections and acquisition as described above can be achieved by fewer components than those of the conventional power supply device. In the present embodiment, components required for every connection points of the paired electrodes are the terminal 16 and wire W. These components can be set in a small space. Therefore, even if the number of the battery cells 2 and 3 increase, it is possible to suppress increase of the numbers of the components and assembling operations thereof, as lower as possible. Thus, it is possible to miniaturize the device and reduce its weight.

The substrate 12 includes the circuit for detecting the abnormal voltages of the battery cells 2 and 3. Accordingly, it is possible to further reduce the number of the components of the power supply device, thus further miniaturization and reduction of the weight become possible.

The circuit pattern 17 has the land 17a for electrode in the vicinity of the terminal 16 for electrode. Accordingly, the land 17a and terminal 16 can be connected through the short wire W1. This can reduce or omit handling wires and preparing spaces for arranging them.

The electrode connecting portion is the terminal 16 formed as a part of the bus bar, and the electrically conductive member is the wire W1. Therefore, each portion for connecting electrodes can be manufactured at the low cost. The terminal 16 and the substrate 12 are connected by the wire W1, and the wire W1 is flexible. Therefore, it is possible to reduce a stress applied to the connection portion at the substrate 12, which is generated when the battery cells 2 and 3 are charged or discharged.

### Second Embodiment

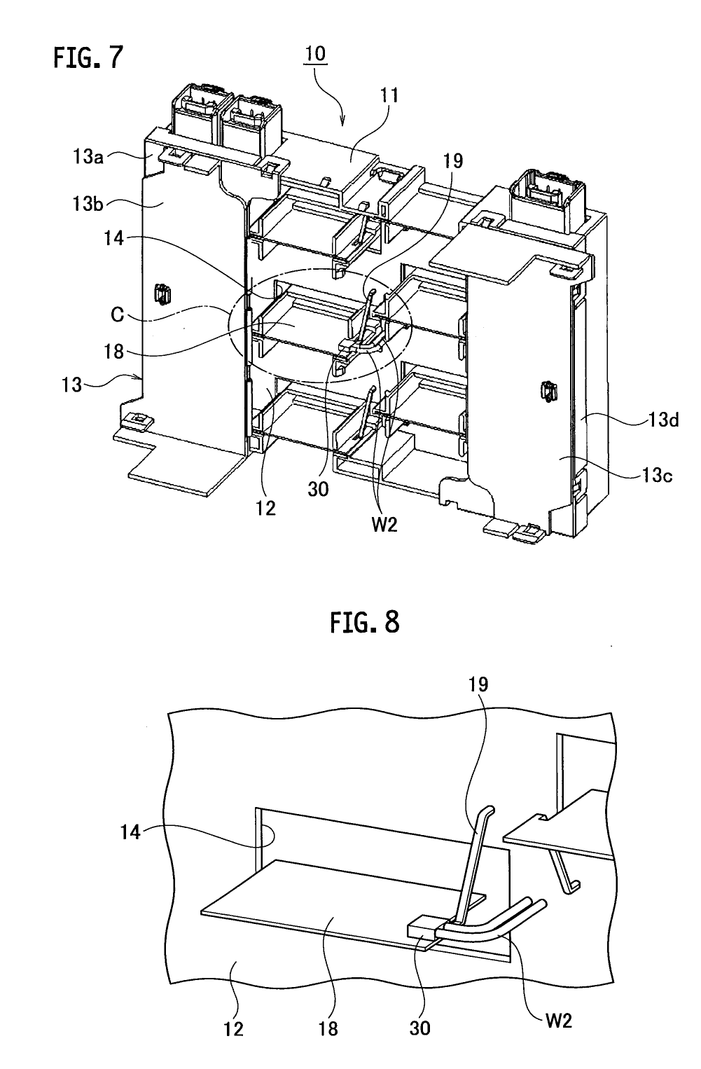

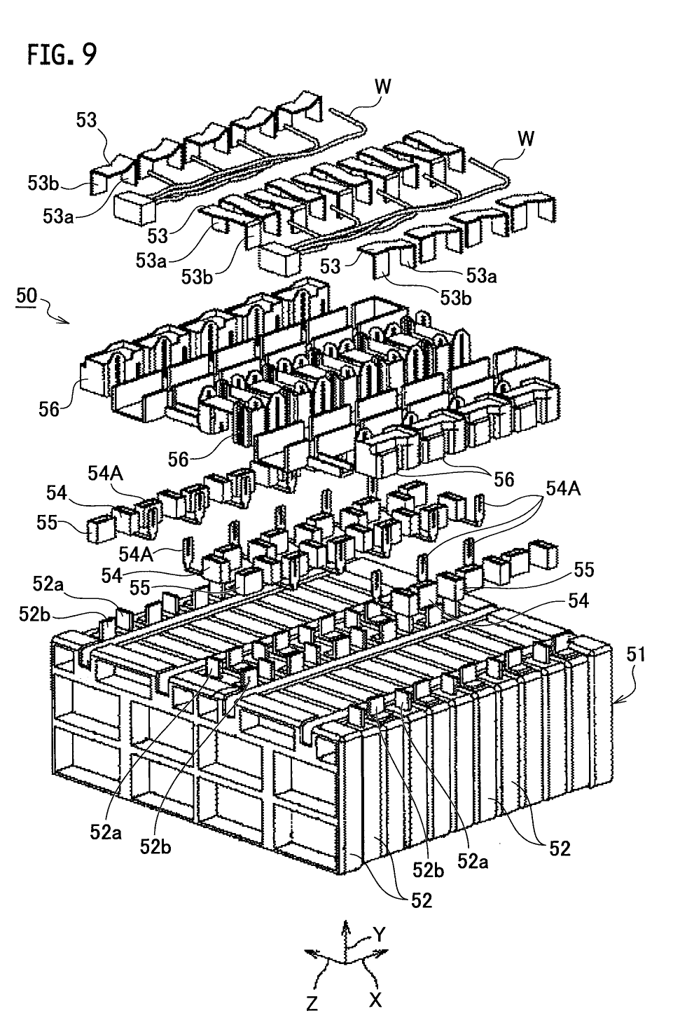

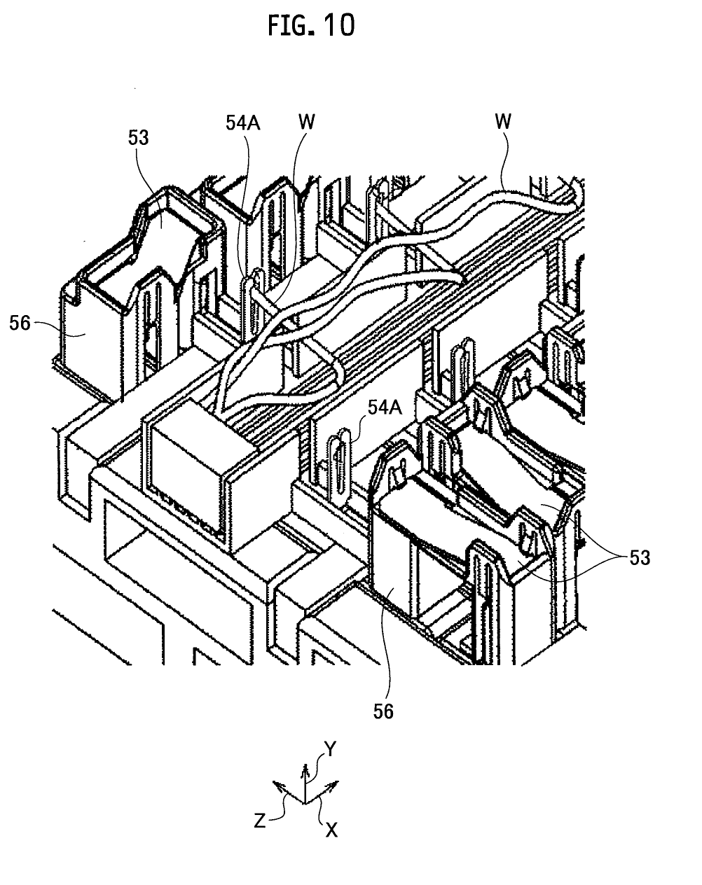

FIGS. 7 and 8 illustrate a second embodiment of the present invention. The second embodiment is different from the first embodiment only in structures of the electrode connecting portion and the electrically conductive member.

As illustrated in FIGS. 7 and 8, a terminal 18 for electrode is served as the electrode connecting portion as described above. The terminal 18 is formed as a part of the bus bar. A tab 19 is served as the electrically conductive member as described above. The tab 19 is integrally formed with the terminal 18 by bending a part of the bus bar. The tab 19 has a bent portion, and is formed into a shape which is easily elastically deformable. As similar to the wire W1 of the first embodiment, a tip end of the tab 19 is connected to the land (not shown) for electrode of the circuit pattern in the substrate 12.

Since other configurations of the second embodiment are the same as those of the first embodiment, the description thereof are omitted to prevent the duplicate explanation.

In the second embodiment, as substantially similar to the first embodiment, the connections between the electrodes 2b and 3b in respective pairs and the acquisition of the information on the voltages thereon can be achieved by fewer components than those of the conventional power supply device. Further, components required for every connection points of the paired electrodes are the terminal 18 and tab 19. These components can be set in a small space. Therefore, even if the number of the battery cells 2 and 3 increase, it is possible to suppress increase of the numbers of the components and assembling operations thereof, as lower as possible. Thus, it is possible to miniaturize the device and reduce its weight.

The terminal 18 and tab 19 are integrally formed with the bus bar. Therefore, the connections between the electrodes 2b and 3b in respective pairs and the acquisition of the information on the voltages thereon can be achieved by further fewer components. The terminal 18 and the substrate 12 are connected through the tab 19, and the tab 19 is elastically deformable. Therefore, it is possible to reduce a stress applied to the connection portion at the substrate 12, which is generated when the battery cells 2 and 3 are charged or discharged.

### Another Embodiment

In the first embodiment, the terminal 16 for electrode is formed as the electrode connecting portion, and the wire W1 is formed as the electrically conductive member. However, a conductor of this wire W1 can be used as the electrode connecting portion. Specifically, the conductor at the tip end of the wire W1 is exposed, and the paired electrodes 2b and 3b are connected by sandwiching the exposed conductor therebetween. This configuration can further reduce the number of the components.

What is claimed is:

1. A power supply device comprising:
a battery assembly including stacked battery cells, the battery cells having electrodes, the electrodes of the adjacent battery cells being placed opposite to one another; and
a battery linking body disposed on a side at which the electrodes of the battery assembly protrude, the battery linking body being configured to cover the protruding electrodes,
the battery linking body including: an electrode connecting portion connected to the electrodes placed opposite to one another, and a substrate with a circuit pattern for voltage detection, the circuit pattern being connected to the electrode connecting portion thorough an electrically conductive portion.

2. The power supply device according to claim 1, wherein the circuit pattern includes a land for electrode in the vicinity of the electrode connecting portion.

3. The power supply device according to claim 1, wherein the electrode connecting portion is a terminal formed as a part of a bus bar, and the electrically conductive member is a wire.

4. The power supply device according to claim 1, wherein the electrode connecting portion is a terminal formed as a part of a bus bar, and the electrically conductive member is a tab integrally formed with the bus bar as a part thereof.

5. The power supply device according to claim 1, wherein the substrate includes a detection circuit for abnormal voltages of the battery cells.
